(19) United States
(12) Patent Application Publication
(10) Pub. No.: US 2019/0340587 A1
(43) Pub. Date: Nov. 7, 2019

(54) Systems and Methods to Maintain a Limited Supply of a Total Number of Existing Units of a Coin in a Platform

(71) Applicant: Signal Zero, Inc., Redmond, WA (US)

(72) Inventor: Tobias Batton, REDMOND, WA (US)

(21) Appl. No.: 16/179,895

(22) Filed: Nov. 3, 2018

Related U.S. Application Data
(60) Provisional application No. 62/581,299, filed on Nov. 3, 2017.
(60) Provisional application No. 62/629,437, filed on Feb. 12, 2018.
(60) Provisional application No. 62/629,798, filed on Feb. 13, 2018.
(60) Provisional application No. 62/654,588, filed on Apr. 9, 2018.

(51) Int. Cl. G06Q 20/06; G06Q 20/36; H04L 9/06; A63F 13/67; A63F 13/69

(52) U.S. Cl. CPC G06Q 20/0655; G06Q 20/3672; A63F 13/69; A63F 13/67; H04L 9/0637

(57) ABSTRACT

Systems and methods to maintain a limited supply of a total number of existing units of a coin are disclosed. In one aspect, embodiments of the present disclosure include a method, which may be implemented on a system, for receiving a seed size of existing units of the coin. The total number of existing units of the coin in the platform can also be determined. The method can further include determining a size of new units of the coin to be created based on one or more of a total number of existing units of the coin in the digital environment and the seed size of the existing units of the coin. In one embodiment, a larger value of the total number of existing units of the coin is associated with a smaller value of the size of the new units of the coin to be created and a lower value of the total number of existing units of the coin is associated with larger value of the size of the new units of the coin to be created.

### CLAIM OF PRIORITY

This application claims the benefit of:
U.S. Provisional Application No. 62/581,299, filed Nov. 3, 2017 and entitled “Systems and Methods of Creating and/or Causing the Creation of New Digital Currency Units Based on Human Activities in a Digital Environment,” (8001.US00), the contents of which are incorporated by reference in their entirety;
U.S. Provisional Application No. 62/629,437, filed Feb. 12, 2018 and entitled “Systems and Methods of Dynamic Game Tournament Creation and/or Prize Attribution in a Gaming Platform,” (8002.US00), the contents of which are incorporated by reference in their entirety;
U.S. Provisional Application No. 62/629,798, filed Feb. 13, 2018, and entitled “Systems and Methods of Tiers-Based Rewarding to Motivate Performance in Measurable Activity,” (8003.US00), the contents of which are incorporated by reference in their entirety;
U.S. Provisional Application No. 62/654,588, filed Apr. 9, 2018, and entitled “Systems and Methods for Intrinsic Value Generation and Creation in Networks of Skill-based Activities or Games on a Distributed Ledger,” (8004.US00), the contents of which are incorporated by reference in their entirety.

### RELATED APPLICATIONS

This application is related to U.S. application Ser. No. 16/179,893, also filed on Nov. 3, 2018 and entitled “Systems and Methods to Generate New Units of a Coin or Currency Having Inherent Value in a Digital Environment” (Attorney Docket No. 99006-8001.US01), the contents of which are incorporated by reference in their entirety.

### TECHNICAL FIELD

The disclosed technology relates generally to creating new coin units having a limited supply through utilizing user skill, activity, or behavior without the need for the traditional resource intensive processes.

### BACKGROUND

It is typically cost prohibitive to participate in mining of digital currencies in a meaningful way because the equipment is very expensive and the process remains resource intensive. As a result, the barrier to entry remains extremely high. Moreover the demand for mining equipment and servers has affected the gaming industry. The limitations and resource requirements associated with the existing method of generating new crypto-currency via mining remains a significant challenge yet to be overcome.

### BRIEF DESCRIPTION OF THE DRAWINGS

FIG. 1 illustrates an example interaction diagram of a host server able to generate new units of a coin or currency having inherent value in a network or across networks in accordance with orders created by game operators/publishers, in accordance with embodiments of the present disclosure.

FIG. 2A-2B depict interaction diagrams illustrating an example of a model where user skill/activity and developer activities cause the mining or creation of new units of a coin or currency, in accordance with embodiments of the present disclosure.

FIG. 3 depicts an example table showing the process for the creation of new units of a coin from order placement, through activity tracking, activity measurement, and attribution of the new coin units, in accordance with embodiments of the present disclosure.

FIG. 4 depicts a process flow showing an example of a how a master supply contract is used in fulfillment of an order for new units of a coin or currency, in accordance with embodiments of the present disclosure.

FIG. 5 depicts an interaction diagram showing an example of a logic and contract flow for generation of new units of a coin, in accordance with embodiments of the present disclosure.

FIG. 6 depicts a chart illustrating the logic governing the relationship between the order seed multiple and the total available units of a coin or currency available, in accordance with embodiments of the present disclosure.

FIG. 7A-7B depict example tables showing prize/reward assignment to different activities or games, in accordance with embodiments of the present disclosure.

FIG. 8 depicts a table illustrating coin or currency attribution to a publisher, users, and/or the platform, in accordance with embodiments of the present disclosure.

FIG. 9 depicts an example block diagram of a host server able to fulfill an order request to create or generate new units of a coin or currency, in accordance with embodiments of the present disclosure.

FIG. 10 depicts a flow chart illustrating an example process for using an order multiple to process an order request to generate new units of the coin or currency, in accordance with embodiments of the present disclosure.

FIG. 11 depicts an example flow chart for using historical data stored on a block chain (e.g., distributed ledger) to determine the number of new coins or currency to be generated in response to an order request, in accordance with embodiments of the present disclosure.

FIG. 12 depicts an example flow chart for determining a size of the order of new coin units to be created based on a total number of existing units of the coin and/or the seed size, in accordance with embodiments of the present disclosure.

FIG. 13A depicts a flow chart illustrating an example process for allocating or attributing the newly generated coins or currency, in accordance with embodiments of the present disclosure.

FIG. 13B depicts a flow chart illustrating another example process for creating new units of a coin or currency, in accordance with embodiments of the present disclosure.

FIG. 14 shows a diagrammatic representation of a machine in the example form of a computer system within which a set of instructions, for causing the machine to perform any one or more of the methodologies discussed herein, may be executed.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Embodiments of the present disclosure include a platform independent, decentralized, controlled/limited supply crypto-asset that is generated as a result of algorithmically tracked player skill or performance in games. Note that a user or gamer's GPUs and CPUs need not be leveraged to generate or mine new assets. The mathematics that are a result of measuring the gamer's relative skill, performance and engagement in a game can be used to generate new coin/currency units.

Embodiments of the present disclosure further include systems and methods to generate and/or attribute new units of a coin (e.g., currency, digital currency, crypto-currency to users (e.g., players) and/or developers (e.g., publishers) through participation in digital activities. Such activities can include, for example, any digital activity including but not limited to game-play inside skill based tournaments. In addition, the games or tournaments can be generated, in some instances, dynamically, on a block chain or distributed ledger. For example, the technology can be implemented via multiple or a series of smart contracts on a block chain such as (but not limited to) Ethereum.

When new coin units are generated, they can be shared between publishers and users (e.g., players, gamers, workers, participants, etc.) so it is a innovative form of game monetization. As a result, paywalls, entry fees and subscription costs are no longer required to monetize a game.

Note that the generated new coin/currency units possess inherent value in the digital and/or physical world and as such function as digital currencies, fiat, coins and/or any other asset or digital asset which can be used to purchase or exchange in receipt of goods and services. For example, elements and properties of the generated coins/currencies (e.g. digital currency, crypto currency, digital asset, cryptoasset, digital reward, etc.) include best practices for coin dynamics and economics. For instance, the coin/currency units can become much more difficult to generate as the supply grows which means there is a limited supply. In another aspect, the generated new coins/currencies are liquid, fungible and exchangeable, so they can be traded or exchanged for other types coins/currencies, digital currencies, crypto currencies and/or crypto-assets. These properties give the coins/units inherent value in any digital environment and/or physical world.

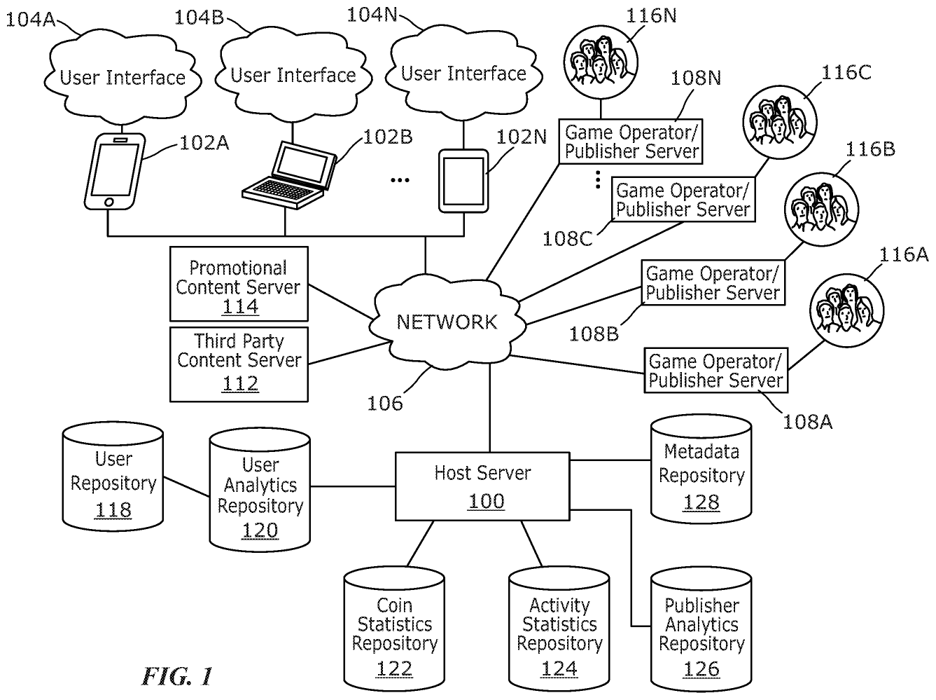

FIG. 1 illustrates an example interaction diagram of a host server 100 able to generate new units of a coin or currency having inherent value in a network 106 or across networks in accordance with orders created by game operators/publishers 108A-N, further based on activities of end users 104A-N.

The client devices 102A-N can be any system and/or device, and/or any combination of devices/systems that is able to establish a connection with another device, a server and/or other systems. Client devices 102A-N each typically include a display and/or other output functionalities to present information and data exchanged between among the devices 102A-N and the host server 100.

For example, the client devices 102A-N can include mobile, hand held or portable devices or non-portable devices and can be any of, but not limited to, a server desktop, a desktop computer, a computer cluster, or portable devices including, a notebook, a laptop computer, a handheld computer, a palmtop computer, a mobile phone, a cell phone, a smart phone, a PDA, a Blackberry device, a Treo, a handheld tablet (e.g. an iPad, a Galaxy, Xoom Tablet, etc.), a tablet PC, a thin-client, a hand held console, a hand held gaming device or console, an iPhone, and/or any other portable, mobile, hand held devices, etc. The input mechanism on client devices 102 can include touch screen keypad (including single touch, multi-touch, gesture sensing in 2D or 3D, etc.), a physical keypad, a mouse, a pointer, a track pad, motion detector (e.g., including 1-axis, 2-axis, 3-axis accelerometer, etc.), a light sensor, capacitance sensor, resistance sensor, temperature sensor, proximity sensor, a piezoelectric device, device orientation detector (e.g., electronic compass, tilt sensor, rotation sensor, gyroscope, accelerometer), or a combination of the above.

The client devices 102A-N, game operator/publisher servers 108A-N, the respective networks of users 116A-N, a content server 112, and/or promotional content server 114, can be coupled to the network 106 and/or multiple networks. In some embodiments, the devices 102A-N and host server 100 may be directly connected to one another. The games provided or developed by the game operator/publisher servers 108A-N can include any online, web-based and/or mobile based games or any other types of activities (e.g., games, games of skill, game of chance, or any other skill-based activities).

In one embodiment, the host server 100 is operable to create or generate new coin or currency units (e.g., cryptocurrency, virtual currency, digital currency, rewards, etc.) through user participation in digital activities in a digital environment (e.g. virtual environment, virtual world, virtual space, simulation, virtual reality, mixed reality, augmented reality, application, or social network). Digital activities can include any of work, action, contest, competition, tournament, labor, and/or event.

The host server 100 can also track and/or measure user activity and/or player performance in participation or engagement in the games or activities (e.g. skill-based activities) provided by the operator/publisher servers 108A-N. In some embodiments, game publishers, developers or other game operators 108A-N can create an order for new units of the coin or currency by implementing a “seed and multiple” system or process that runs as a series of smart contracts on a block chain or a distributed ledger. In general, the entities represented by 108A-N can include by way of example, a developer, a publisher, an owner, an operator, a proprietor, an admin, a modder, a user generator, and/or a partner.

In general, the host server 100 operates in real-time or near real-time and is able to generate new coin/currency units based on human activity in a digital environment. The host server 100 can also process and implement new coin order requests (typically placed by entity 108A-N) and facilitate order fulfillment by allowing users or players to participate in the activities (e.g., as specified or defined by the entity 108A-N).

In one embodiment, the host server 100 is further able to collect and/or generate useful analytics/statistics regarding game play and user participation/performance. In addition, using historical game session data and/or historical player performance data, the host server 100 is able to calculate, determine or estimate a reward value, a payout value or values that can be awarded to users, players and/or participants. Using statistical information and/or performance metrics, the host server 100 can also determine the number of new coin units to be generated and/or allocated to users/players 102A-N and entity 108A-N (e.g., publishers, developers, etc.).

Note that historical player performance data or statistics can be generated or computed using recent session data from playing or otherwise participating in a given activity. As such, the host server 100 can in one embodiment, be a predictive engine which is able to forecast future player performance and determine, compute or estimate a reward or payout value(s) based on previous or recent player performance for a given game or activity.

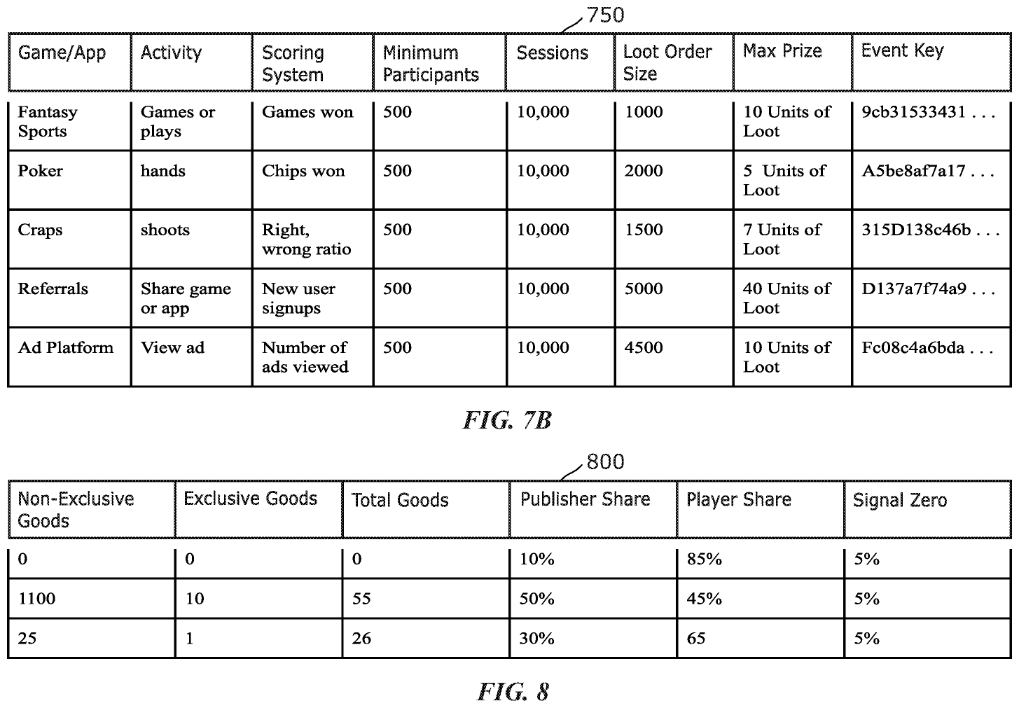

Functions and techniques performed by the host server 100 and the components therein are described in detail with further references to the examples of FIG. 9.

In general, network 106, over which the client devices 102A-N, the host server 100, and/or various game operator/publisher servers 108A-N, content server 112, and/or promotional content server 114 communicate, may be a cellular network, a telephonic network, an open network, such as the Internet, or a private network, such as an intranet and/or the extranet, or any combination thereof. For example, the Internet can provide file transfer, remote log in, email, news, RSS, cloud-based services, instant messaging, visual voicemail, push mail, VoIP, and other services through any known or convenient protocol, such as, but is not limited to the TCP/IP protocol, Open System Interconnections (OSI), FTP, UPnP, iSCSI, NSF, ISDN, PDH, RS-232, SDH, SONET, etc.

The network 106 can be any collection of distinct networks operating wholly or partially in conjunction to provide connectivity to the client devices 102A-N and the host server 100 and may appear as one or more networks to the serviced systems and devices. In one embodiment, communications to and from the client devices 102A-N can be achieved by an open network, such as the Internet, or a private network, such as an intranet and/or the extranet. In one embodiment, communications can be achieved by a secure communications protocol, such as secure sockets layer (SSL), or transport layer security (TLS).

In addition, communications can be achieved via one or more networks, such as, but are not limited to, one or more of WiMax, a Local Area Network (LAN), Wireless Local Area Network (WLAN), a Personal area network (PAN), a Campus area network (CAN), a Metropolitan area network (MAN), a Wide area network (WAN), a Wireless wide area network (WWAN), enabled with technologies such as, by way of example, Global System for Mobile Communications (GSM), Personal Communications Service (PCS), Digital Advanced Mobile Phone Service (D-Amps), Bluetooth, Wi-Fi, Fixed Wireless Data, 2G, 2.5G, 3G, 4G, 5G, IMT-Advanced, pre-4G, 3G LTE, 3GPP LTE, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, UMTS-TDD, 1×RTT, EV-DO, messaging protocols such as, TCP/IP, SMS, MMS, extensible messaging and presence protocol (XMPP), real time messaging protocol (RTMP), instant messaging and presence protocol (IMPP), instant messaging, USSD, IRC, or any other wireless data networks or messaging protocols.

The host server 100 may include internally or be externally coupled to a user repository 118, a user analytics repository 120, a coin statistics repository 122, an activity statistics repository 124, a publisher analytics repository 126 and/or a metadata repository 128. The repositories can store software, descriptive data, images, system information, drivers, and/or any other data item utilized by other components of the host server 100 and/or any other servers for operation. The repositories may be managed by a database management system (DBMS), for example but not limited to, Oracle, DB2, Microsoft Access, Microsoft SQL Server, PostgreSQL, MySQL, FileMaker, Hadoop, etc.

The repositories can be implemented via object-oriented technology and/or via text files, and can be managed by a distributed database management system, an object-oriented database management system (OODBMS) (e.g., ConceptBase, FastDB Main Memory Database Management System, JDOInstruments, ObjectDB, etc.), an object-relational database management system (ORDBMS) (e.g., Informix, OpenLink Virtuoso, VMDS, etc.), a file system, and/or any other convenient or known database management package.

In some embodiments, the host server 100 is able to generate, create and/or provide data to be stored in the user repository 118, the user analytics repository 120, the coin statistics repository 122, the activity statistics repository 124, the publisher analytics repository 126 and/or the metadata repository 128. The user repository 118 and/or user analytics repository 120 can store user information, user profile information, demographics information, analytics, statistics regarding game play, game participation, user skill, and/or user historical performance for any number of activities, games across one or multiple types of games/activities.

One embodiment further includes the coin statistics repository 122 which can store information or metadata about coin supply and/or rate of change of coin supply. A further embodiment includes the activity statistics repository 124 which is able to store statistical information aggregated from games and/or other activities.

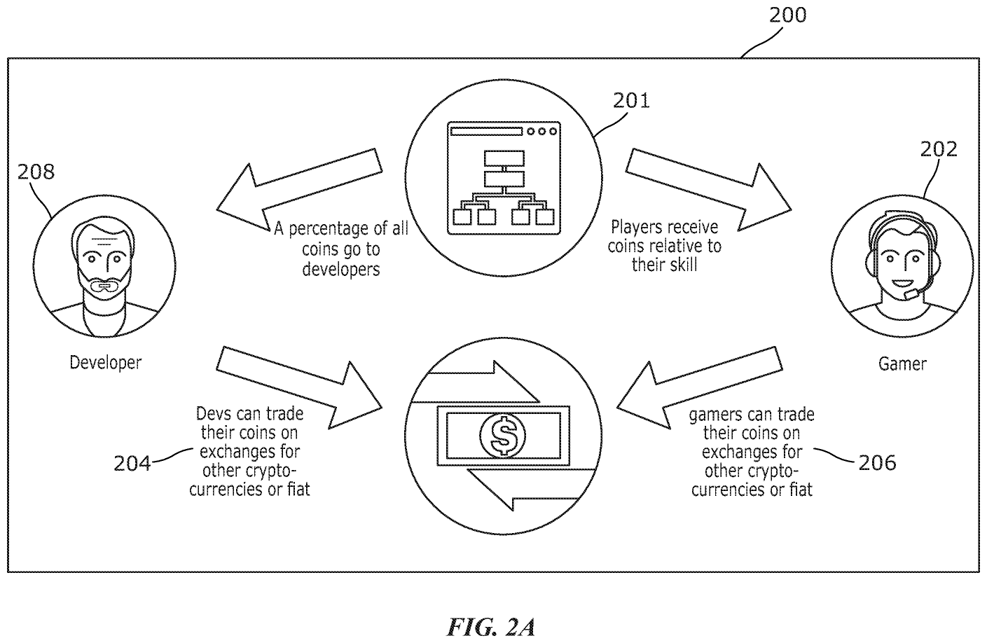

FIG. 2A-2B depict interaction diagrams illustrating an example of a model where user 202 skill/activity and developer 208 activities cause the mining or creation of new units of a coin or currency.

Example diagram 200 depicts a game or activity 201 specified, defined, created or generated by developer/publisher 208. The player/user/gamer 202 is able to engage in the game or activity 201 and receive newly created coins/currency. In general, once the game or activity 201 is performed to the criteria of specification set by the developer 208, an order of the new coin or currency units can be considered to be fulfilled. Once fulfilled, the gamer 202 can then receive an allocation of the new coin/currency units.

Note that in one embodiment, the amount of new coin/currency received by the gamer/player 202 depends on their skill or performance in performing the activity. The amount of new coin/currency received by the gamer/player 202 can also depend on their ‘relative’ skill in comparison with other players/users/gamers or in comparison with historical game session data or historical performance statistics. In addition, a portion or percentage of the newly generated coins can be allocated to the developer 208.

Note that regardless of the type of coin or currency awarded or allocated to the developer 208 and the gamer 202, the coins/currency can be exchanged for other coins, other types of cryptocurrency/digital currency and/or fiat money. For example, when gamers play video games with coins or digital currencies their activity can be tracked and measured directly on the block chain (e.g., any distributed ledger). As a result new tokens are minted in proportion to the gamer's relative skill and engagement.

In accordance with embodiments of the present disclosure, as the coin supply grows, it becomes increasingly difficult to mint new coins/currency units. This means that the amount of activity or relative skill required to create a new coin unit across activities or games increases over time. This is an example process underlying new coin/currency generation in across games, apps and activities.

While a difficulty curve that tends towards infinity does not create an arbitrary cap, minting new coin units may reach a point that the number of new coin units that can be minted can become flat or even negligible. Bitcoin and other crypto-assets have been so successful, in part, because work and risk have been built-in to the systemics behind the creation of new coin units. Work and risk lends itself conceptually to the creation of new value. Further, these systemics are visible to everyone within the blockchain itself.

Generating new coin units starts with a game publisher or developer creating a new order for the new coin/currency units on the blockchain. Game publishers, developers or other game operators can create an order for new units of the new coin units via a “seed and multiple” system that can be executed as processes on the blockchain.

TABLE I

| Seed (Input) | Multiple (Derived) | Order (Output) |
|---|---|---|
| 10 Units of Loot | 100x | 1000 Units of Loot |

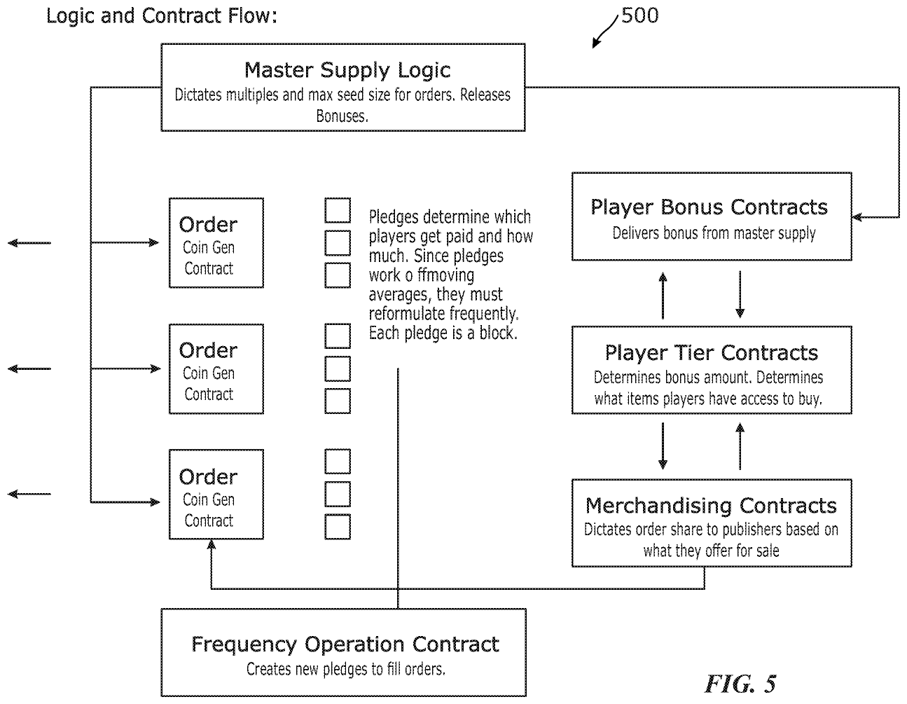

Note that seeds cannot be used to make multiples of new units of coins without criteria or out of thin air. In general, gamers/users playing games are required to fill the order request for new coin units with their game play or other form of activity participation. Depending on the total amount of coin units available in any given digital realm or worldwide at that time (current supply amount), a logical process running on the blockchain can assign a multiple to the order that is based on the seed size. So, if the publisher uses 10 coin units for their seed and the multiple is 100, the publisher will create an order for 1000 units of the coin/currency, as shown in the example of Table I above. The more new coin units that get created over time, the lower the multiple becomes. An example of the master supply logic which governs the relationship between an order seed multiple and total available coins is illustrated in FIG. 6.

As such, as illustrated in diagram 250, to limit the supply of coins, developers 208 can submit or pay coins (or a seed amount) to create activities or challenges inside their games. Each activity/challenge can then in turn produce a limited number of coins which is a multiple of the initial (seed) amount of coins submitted or deposited (e.g., 10×, 100×, 1000×, 5000×, etc.). In some instances, when the coins are depleted, they are not able to be replenished by the developer. In general, developers 208 can create unlimited number of challenges in their games 201 as long as they pay for them using seed amounts of existing coin units,

To limit returns paid back to gamers/users 202, gamers/users 202 can generally participate in activities/challenges at little to no cost, or for free. The more players that are active in a given challenge, the more difficult it is to win coins or in other words cause new coins to be generated. In some embodiments, gamers/players 202 can also wager coins they have won against other players to win additional coins faster. Note that once a limited supply of new coins ordered by the developer 208 has been already fulfilled, gamers/players 202 can win in a given challenge with a wager.

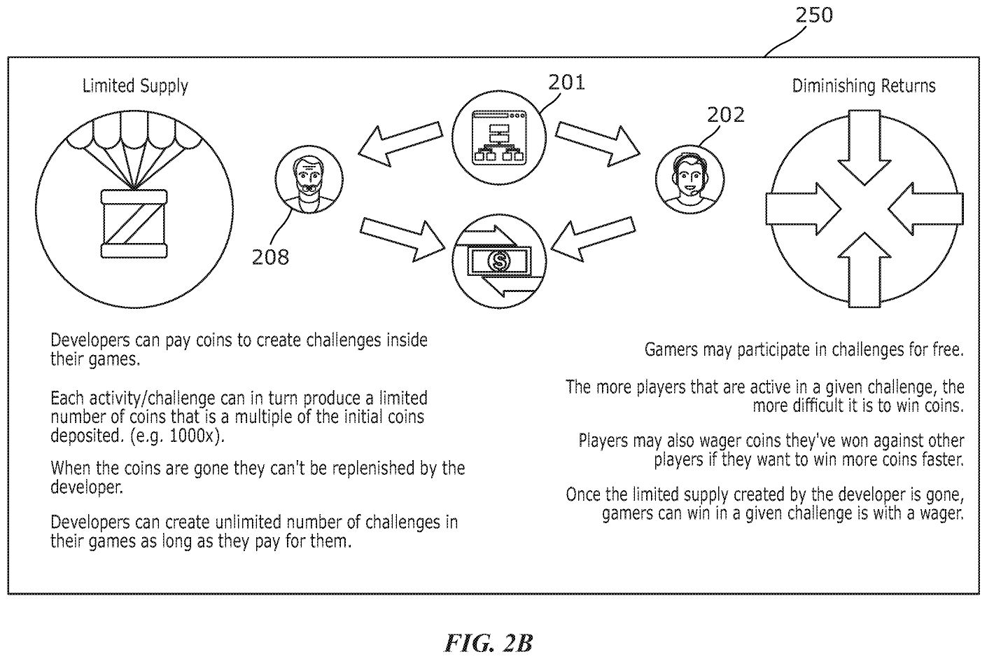

FIG. 3 depicts an example table showing the process for the creation of new units of a coin from order placement, through activity tracking, activity measurement, and attribution of the new coin units.

In step 302, an order is placed. In placing an order, an entity (e.g. publisher/developer) determines an in-game activity. A max currency amount that can be newly created through fulfillment of the order through user participation in the activity can also be defined or specified by the entity. In addition, the entity can determine the allocation or attribution of the newly generated coins/currency to the user(s) who participated in the activity and the entity.

In step 304, human activity in participating in the defined in-game activity can be tracked. When users take part in the defined activity from step 302, user data can be tracked and stored programmatically as a result of activity. In step 306, human activity can be measured. For example, user data, statistics, and historical game session data can be used to compare user performance or relative user performance. The results of such comparison can be used to facilitate calculation or to determine the number or amount of new currency that can be generated or will be generated.

In step 308, new units of the coin/currency is created. Note that new coin or currency units are generally created or generated based on activity data, measurements, performance data and/or historical game session statistics. In step 310, the currency attribution step occurs in which allocation of the new coin or currency units to the developer and/or the player/user is determined. For example, new coin/currency units can be rewarded based on activity data, measurement, performance data and/or historical game session statistics.

For example, the amount of the order that is attributed to the publisher can start at 20% but can increase based on whether or not the publisher will accept a certain coin or currency as payment for its in-game items and games. In one embodiment, the largest percentage of coins a publisher can receive is around or near 50%. This allocation can be beneficial to incentivize publishers to help increase the demand for the coin, as well as the supply.

In some embodiments, publishers can also set whether or not to automatically reseed. For example, the following settings are configurable by a publisher/developer:
1. Automatically reseed with identical settings if order is filled
2. Do not automatically reseed if order is filled
3. Reseeds only work if existing units of the coin/currency are available in specified wallet, otherwise they fail

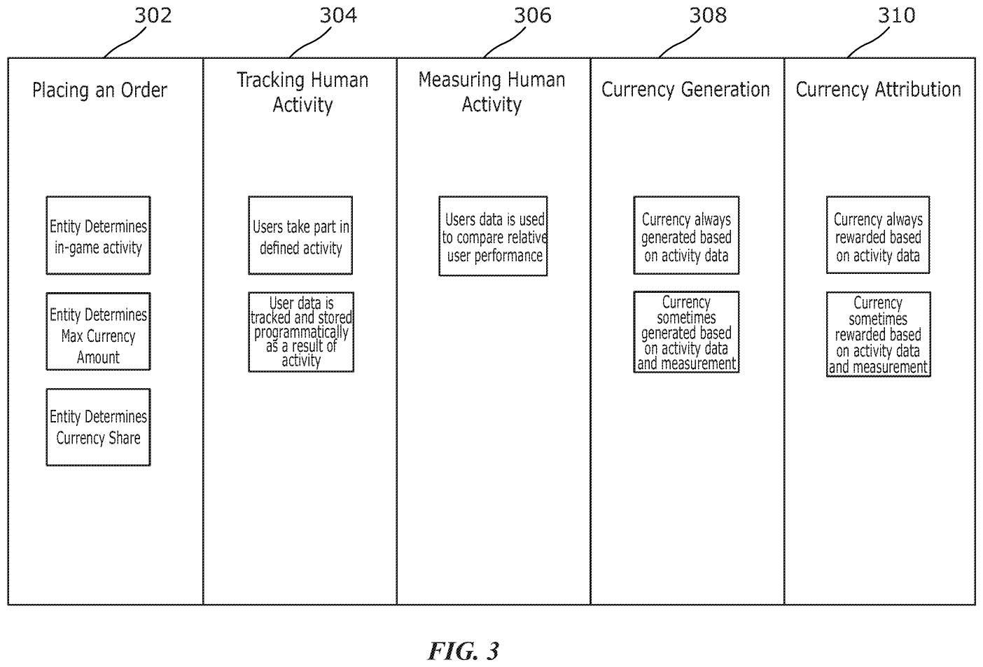

FIG. 4 depicts a process flow showing an example of a how a master supply contract is used in fulfillment of an order for new units of a coin or currency.

In step 402, a master supply contract can for example, track global coin supply and can be used to determine or dictate order multiples. Each order's multiple can be determined by the supply contract. The master supply contract can carry an asymptotic easing supply curve, for example. In step 404, a publisher order is created. The publisher order can include order requests and order specifications for new units of the coin/currency.

In step 406, a game pledge (e.g., a mini order that determines player reward or payout) is created. Game pledges can be created to help full orders. Each pledge can conduct or carry the mathematical calculations used to determine player pay-out so players can receive their new coins/currency. The pledge can also predict future performance based on historical game session data and/or histograms of performance.

In step 408, a frequency operation which can track average variance is carried out. The frequency operation can continually determine the accuracy of the previously calculated average is, and determine if a new pledge is needed.

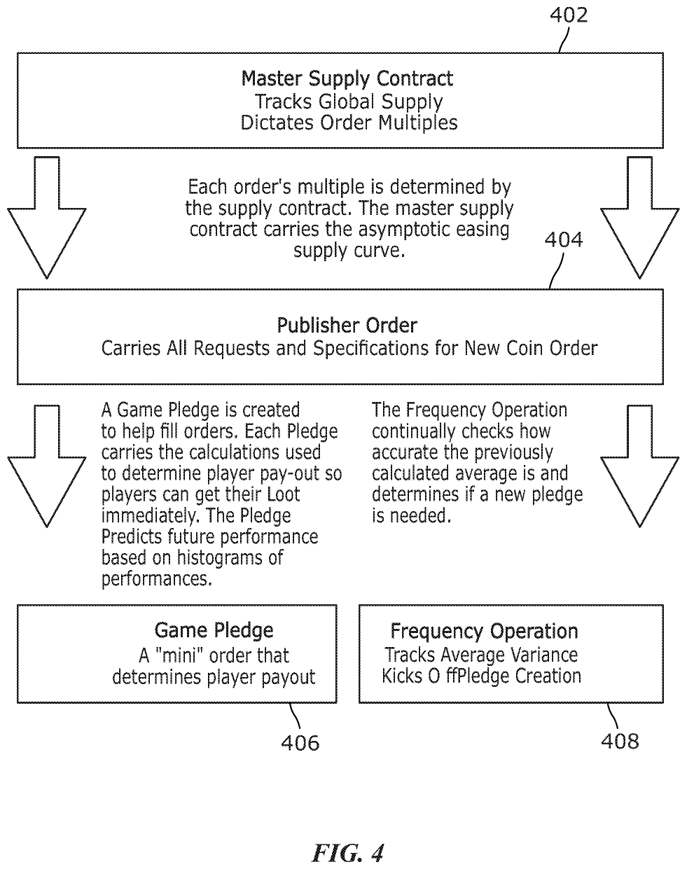

FIG. 5 depicts an interaction diagram 500 showing an example of a logic and contract flow for generation of new units of a coin. FIG. 6 depicts a chart 600 illustrating the logic governing the relationship between the order seed multiple 602 and the total available units of a coin or currency 604 available over a period of time 606.

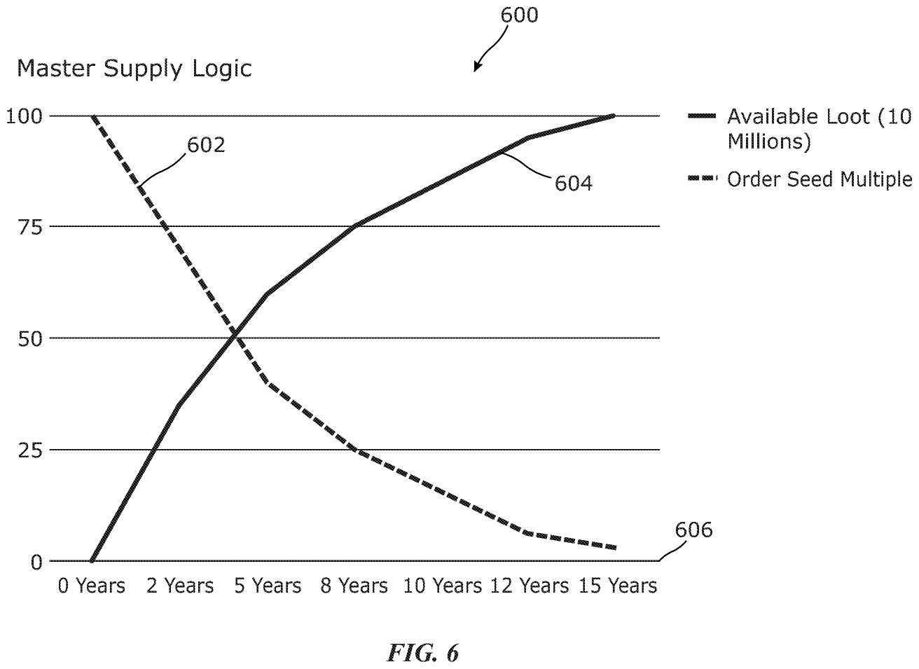

FIG. 7A-7B depict example tables showing prize/reward assignment to different activities or games.

Publishers can select the activity in their game that they want players to engage with to create and win new tokens. The activity in the game is tracked with an encrypted key-based event system. In addition, publishers can define the number of gameplay sessions (scores) required to fill the entire order. This parameter can, for example, have a min and a max associated with it. A “lookback” window can be a percentage of sessions defined. Note that the max prize for any player is generally a derived value. This amount is displayed to publishers. Max prizes can be capped to help insure orders don't fill too quickly.

Note that in addition to games, the coin generation and creation process can be used in other applications, as illustrated in table 750.

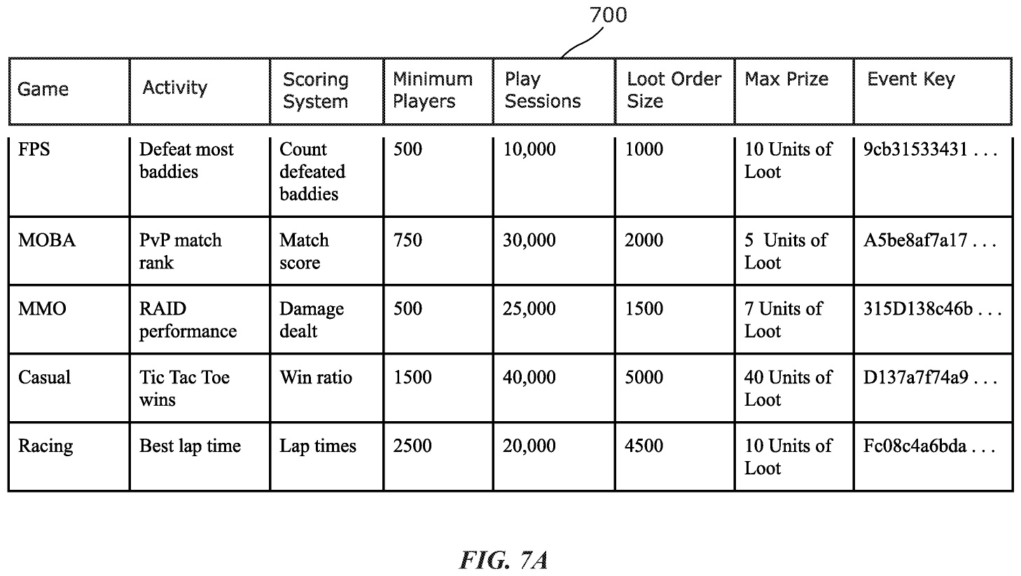

FIG. 8 depicts a table 800 illustrating coin or currency attribution to a publisher, users, and/or the platform.

The amount of the order that can be attributed to a developer/publisher starts at a lower percentage and can increase based on whether or not the developer/publisher will accept a given type of coin/currency as payment for its in-game items, special content and full games. In addition, the largest percentage or near largest percentage of new coin units a publisher can receive or can be allocated can be capped. This can incentivize publishers to help increase the demand for the coins with their items.

FIG. 9 depicts an example block diagram of a host server 900 able to fulfill an order request to create or generate new units of a coin or currency.

The host server 900 can include, for example, a network interface 902, an order processing engine 910, an attribution engine 915, an activity engine 930, a new coin generator 940, a coin tracker 950, and/or a block chain manager 955. Additional or less components/modules/engines can be included in the host server 300 and each illustrated component.

The network interface 902 can be a networking module that enables the host server 900 to mediate data in a network with an entity that is external to the host server 900, through any known and/or convenient communications protocol supported by the host and the external entity. The network interface 302 can include one or more of a network adaptor card, a wireless network interface card (e.g., SMS interface, WiFi interface, interfaces for various generations of mobile communication standards including but not limited to 1G, 2G, 3G, 3.5G, 4G, LTE, 5G, etc.), Bluetooth, a router, an access point, a wireless router, a switch, a multilayer switch, a protocol converter, a gateway, a bridge, bridge router, a hub, a digital media receiver, and/or a repeater.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or have its functionality distributed in part or in full. The module, manager, tracker, agent, handler, or engine can include general or special purpose hardware, firmware, or software embodied in a computer-readable (storage) medium for execution by the processor.

As used herein, a computer-readable medium or computer-readable storage medium is intended to include all mediums that are statutory (e.g., in the United States, under 35 U.S.C. 101), and to specifically exclude all mediums that are non-statutory in nature to the extent that the exclusion is necessary for a claim that includes the computer-readable (storage) medium to be valid. Known statutory computer-readable mediums include hardware (e.g., registers, random access memory (RAM), non-volatile (NV) storage, flash, optical storage, to name a few), but may or may not be limited to hardware.

One embodiment of the host server 900 includes the order processing engine 910. The order processing engine 910 can be any combination of software agents and/or hardware modules (e.g., including processors and/or memory units) able to receive, detect, process, manage, track, store, save, orders to generate or create new units of a coin which have inherent value within a platform, multiple platforms, digital environment, digital realm, and/or the real world, and/or to facilitate the fulfillment of the order of the new coins/currency.

Game publishers, developers or other game operators can create an order for new units of the coin/currency (e.g., digital asset, digital currency, crypto-currency, crypto-asset, etc). By following a “seed and multiple” system able to be executed as a series of logical processes, for example, on a block chain. The process begins with a game operator sending an existing amount of coins/currency (e.g., from their crypto wallet to a block chain). This order can in some instances be submitted via a web based order form. This “seed” opens the order system and allows the publisher to input desired settings.

One embodiment of the order processing engine 910 further includes an order recorder 914 to record or manage various orders for new coin units. A seed size analyzer 912 can also be included in the order processing engine 910 to determine the amount of existing coin units submitted with the order for new coin units. The seed size and/or a total number of coin supply available can be used individually or together to determine a number of new coin units to be generated.

One embodiment of the host server 900 further includes an activity engine 930. The activity engine 930 can be any combination of software agents and/or hardware modules (e.g., including processors and/or memory units) able to detect, identify, track, monitor, facilitate, manage, deploy any number of activities (e.g., work, game, etc.) in a digital environment or digital platform. The activities can be engaged in or participated in by end users (e.g., consumers, gamers, players, workers, or any other participants, etc.) to facilitate or trigger creation of the new coin/currency units which have inherent value.

In general, the settings in specifying an order request can include an activity specified to be completed or engaged in by a user/player to facilitate creation of the new coin units. Game activities can be tracked (e.g., by the tracking engine 932) and/or the user/player performance can also be measured. The tracking engine 932 can be any combination of software agents and/or hardware modules (e.g., including processors and/or memory units) able to detect, track, aggregate, generate, create, game statistics, game scores, progression or performance across multiple users and/or over a look back period of time or game sessions. In order to make a prediction about future game activity or performance, the game tracking engine 932 can track or aggregate scores over a number of game sessions/instances. The game tracking engine 932 can also determine, for example, the lowest score or a near lowest score, the highest score, or a near highest score and an average (mean) score, for use in generating useful statistics or data over one or more game sessions/instances.

The publishers/developers can define various criteria (e.g., game play sessions, scores, game play frequency, participation/engagement frequency, etc.) to be met for the order to be partially or fully filled. The criteria can be tracked, for example, by the criteria management engine 934.

One embodiment of the host server 900 further includes a new coin generator 940. The new coin generator 940 can be any combination of software agents and/or hardware modules (e.g., including processors and/or memory units) able to create, generate, facilitate the creation or generation of new coin/currency (e.g., digital currency, crypto currency, crypto asset, etc.) units. The new coin generator 940 can communicate with the order processing engine 910 and/or the activity engine 930 and accordingly generate the appropriate number of new coin/currency units.

One embodiment of the new coin generator 940 includes one or more of an order size calculator 940, a seed size manager 944 and/or a seed size multiplier. Depending on the total amount of existing coins/currency available (e.g., in the platform, in a digital environment, in a specified environment, and/or worldwide, etc.) at that time (current supply amount), a process (e.g., a process executing in part or in whole on a block chain) can assign a multiple (e.g., by the seed size multiplier 946 and/or the order size calculator 942) to the order that is based on the seed size. By way of example, if the publisher uses 10 units of existing coins for their seed and the multiple is 100, the publisher can create an order for 1000 units of new coin units. The more new units of the coin/currency that gets created over time, the lower the multiple can become (e.g., as determined by the seed size multiplier 946).

In one embodiment, seed size can be be capped in the master supply logic (e.g., by the seed size manager 944). The max seed size allowed can be, for instance, governed by the event horizon date set in a master supply contract (e.g., as illustrated in FIG. 4-FIG. 5). If new coin creation is happening too quickly or is happening at a rate above or near a specified threshold, the max seed size can be lowered. If new coin creation is happening too slowly in relation to the event horizon date, max seed size is increased. This relationship is illustrated in Table II below. Note that in some instances, max seed size may not increase after a certain point, which is the hard cap.

The seed size manager 944 and seed size multiplier 946 can work together as governing agents/components to ensure that the new coin supply is generated at a controlled or predetermined rate.

TABLE II

| Starting Max Seed | | | Resulting Max Seed |
|---|---|---|---|
| Size | Supply Growth | Modifier | Size |
| 1000 | Too Fast | ⬇ Decrease | 100 |
| 100 | Too Slow | ⬆ Increase | 1000 |

One embodiment of the host server 900 further includes a coin tracker 950. The coin tracker 950 can be any combination of software agents and/or hardware modules (e.g., including processors and/or memory units) able to determine, track, compute, ascertain the amount of existing supply of coin/currency (e.g., digital currency, crypto currency, crypto asset, etc.) units available in or around a specified time, time range, or time period. The coin tracker 950 can also include on or more of the coin calculator 952 and/or a coin rate change tracking engine 954.

One embodiment of the host server 900 further includes a block chain manager 955. The block chain manager 955 can be any combination of software agents and/or hardware modules (e.g., including processors and/or memory units) able to manage, write, record, access, store, data onto any block chain or distributed ledger or retrieve, access, read data from a block chain or distributed ledger. The block chain manager 955 can further include an order recordal engine 956, an activity recordal engine 957, and/or a statistics recordal engine 958.

For example, various transactions, new coin order requests, activities, statistics, games session data, events and player performances can be recorded on a block chain or distributed ledger (e.g., by the order recordal engine 956, activity recordal engine 957 and/or the statistics recordal engine 958).

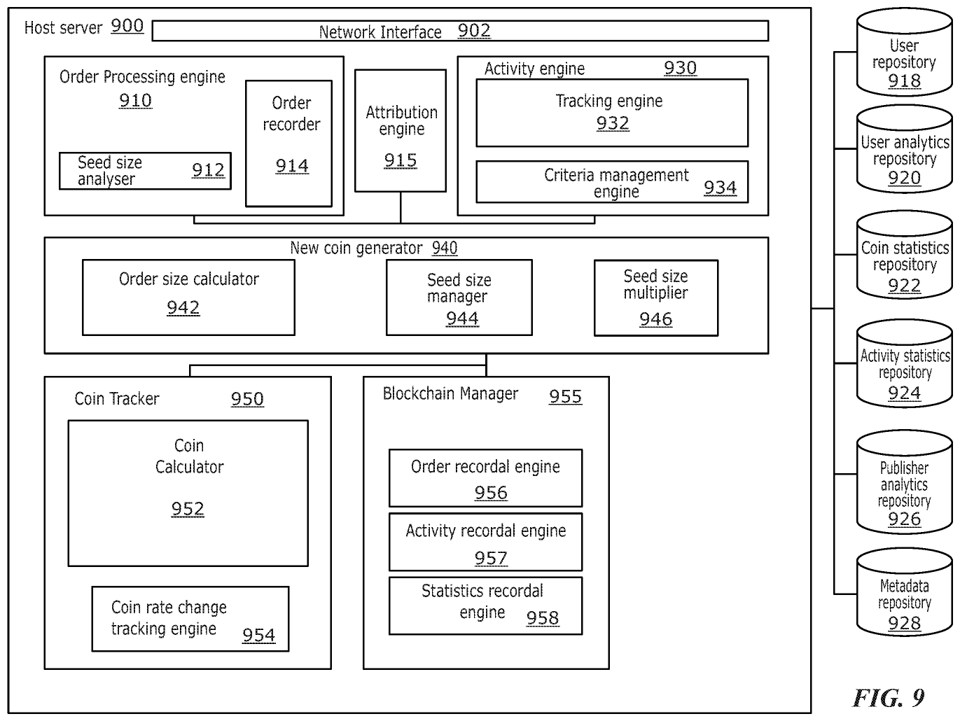

FIG. 10 depicts a flow chart illustrating an example process for using an order multiple to process an order request to generate new units of the coin or currency.

In process 1002, an order request to generate the number of units of the coin is received. The new units of the coin (e.g., currency) can be placed by an entity (e.g., an entity external to the platform) via the host or platform. In general, the entity can be any third party entity including by way of example, but not limited to a game developer, a publisher, an owner, a partner, an administrator, or a proprietor, to name a few, etc.

In generating or creating the order request, the entity can specify or identify an event or activity (e.g. an activity in a game) that can be leveraged or is associated with the generation of new coin units. The activity, can be for instance, logging into a game, or an activity involving more skill like shooting enemies, killing wolves, or capturing hearts, for example.

In process 1004, an order multiple is assigned to the order request. The order multiple, which can be determined by or derived from global supply works together with the max seed size cap, which is governed by time to insure that the global supply is not mined too easily or too quickly. In addition, the order multiple can be determined based on the size of the order request, which is generally specified in a number of units of the coin/currency. The order multiple can also be determined based on a supply of units of the coin available in the digital environment and/or a speed or rate of creation of units of the coin in the digital environment.

For example, the order multiple can be assigned a lower value corresponding to a higher supply of units of the coin and the order multiple can be assigned a higher value corresponding to a lower supply of coins. In addition, a maximum or near maximum size of the order request can be determined based on speed or rate of creation of units of the coin in the digital environment. In one embodiment, once the multiple is assigned to the seed (e.g., the order request), the seed can be destroyed on chain.

To place the order request, the entity can further specify or define a size of the order request which can be set by an amount of coin or currency that can be generated in association with the occurrence of the event or performance of the activity. In one embodiment, entities can determine the maximum amount of new currency units (e.g., new digital or cryptocurrency units) that can be generated by a specific activity in the game that they are operating via the platform. Entities may determine this amount arbitrarily or non-arbitrarily. Entities may determine static, or dynamic amounts. Some examples of arbitrary determination can include,
Static: Entity may set a cap on the amount of crypto-currency that can be won by reaching the second level of their game based on no logic or rules, simply because the amount “sounds right” to them.
Static: Entity may use random number generation to determine the max amount of crypto currency that can be generated by killing a “boss” in a game.
Dynamic: Entity may allow one unit of currency to be generated each time a user kills a certain boss, without a cap.

Some examples of non-arbitrary determination methods (includes but not limited to):
Static: The amount of crypto currency available to be generated in a game activity is determined by a deposit of same or different currency. (For example entity deposits 1 currency unit, and 1000× currency units become available to be generated based on human activity in the game).
Dynamic: The amount of crypto currency available to be generated in a game activity is derived from the relative popularity of the activity and/or its number of participants and is therefore both non-arbitrary and dynamic.

In process 1006, the number of units of the coin is determined based on a size of the order request and/or the order multiple. Once there is an order request, users (e.g., players, workers, consumers, customers, etc.) engage with the platform in various ways to fulfill the order for the new coin units, for instance, as specified by the entity. Users can engage with the platform to fulfill the order in a variety of mechanisms, including but not limited to performing certain specified activities in a digital environment, for example, a gaming environment.

In process 1008, an activity is detected in the digital environment. The activity when performed can cause the creation of the number of units of the coin. Such activities are generally specified or defined by a publisher/developer in creating the order request. Examples of the activities which can be performed by users to fulfill order requests, and detected by the system/platform are illustrated as follows:

In one embodiment, new units of crypto-currency can now be generated based on human engagement in a game. Engagement Examples (Including but not limited to):
Opening, loading or booting the game
Starting the game from the menu
Playing through a tutorial
Reaching the second level of the game

In a further embodiment, new units of crypto-currency can also be generated based on human performance in a game. Examples of human performance include by way of example but not limitation:
Killing another human user's avatar inside of the game
Winning a race, especially against other human controlled users in a game.
Beating another user in a basketball game, especially when the opposing team is controlled by another user.

New units of crypto-currency can now be generated based on human achievement in a game. Achievement Examples (Including but not limited to):
Getting a high-score
Scoring any number of points
Killing a certain quantity of the same kind of NPC (Non Player Character)
Collecting a certain quantity of an item

New units of crypto-currency can now be generated based on human socialization in a game. Socialization examples include by way of example but not limitation:
Inviting friend to sign up or play
Friends signing up or playing as the result of an invite
Posting meta-data from inside the game to social media

New units of crypto-currency can now be generated based on human exploration in a game. Exploration Examples include by way of example but not limitation:
Reach the top of a mountain in the game
Swim across a lake
Be the first user to see a place, object or item.

New units of crypto-currency can now be generated based on any trackable human activity in a game. Other Examples include:
Mining ore out of a virtual ore vein
Crafting or building new items or structures
Staying alive for a certain amount of time or under certain conditions

In process 1010, the occurrence of an activity is tracked in the digital environment. In one embodiment, occurrence of the activity corresponds to creation of coin in the digital environment. To determine if the work is completed, the activity or work is tracked by the platform. Data pertaining to the work or activity is tracked and/or stored to authenticate or otherwise ascertain that the entity's order has been filled by activities performed by a user. Note that in some instances, measurement of the activity is not needed and the tracking data can be used to create or generate the new coin units as in process 1014.

Note that in some instances, measurements is used to generate new coin units and the coins are not generated until after measurements are performed in process 1011 on the activity or work performed by the user. In these circumstances the system can measure the various user performances against each other to understand which performances are responsible for the creation/generation of the static order amount of coins. In one embodiment, the performance of the player is determined using historical sessions in performing the activity in the game.

If the activity called for 100 coins to be generated and you have 3 users with equal scores, each user is responsible for 33.33 coins. In another example, it user 1 scored 500, user 2 scored 400 and user 3 scored 100 then 100 coins would be generated with user 1 responsible for 50 of them, user 2 responsible for 40 of them and user 3 responsible for 10 of them.

A further embodiment of the present disclosure is measuring or comparing human activity. The innovation (sometimes but not always) can require technology that measures relative human activity in a given sample set. Some examples include:
What percentile does a user fall in given a sample set of user scores
Did the user win a contest, or where do they fall in the stack rankings
How much time did the user spend actively in the game in relation to other users.
What percentage of users completed an achievement in the sample set
How much activity was generated by a user that was invited by another user

When entities order coins with the platform, sometimes the system can generate them based on measurement. Sometimes the system generates new coin units without measurement. Note that in some embodiments, user performance can also be measured and determined against a static or dynamic threshold or criteria. In process 1012, it is determined that the activity has occurred to meet a criteria. In one embodiment, the criteria includes a number of times the activity has occurred in the digital environment. In process 1014, the number of units of the coin is generated in the digital environment.

In some instances, the activity occurs in a game for a player to engage with to generate the number of units of the coin and the criteria can include a number of occurrences of the activity or a frequency of occurrences of the activity in the game. In one example, the activity occurs in a poker game for a player to engage with to generate the number of units of the coin and the activity includes hands in the poker game. The activity can occur in a craps game for a player to engage with to generate the number of units of the coin and the activity includes shoots in the craps game.

In a further example, the activity can occur in a referrals service for a user to engage with to generate the number of units of the coin and the activity can include shares in the referrals service.

The activity can also occur in an advertisement or promotional service for a user to engage with to generate the number of units of the coin. In this example, the activity can include, for instance, ad views in the advertisement or promotional service.

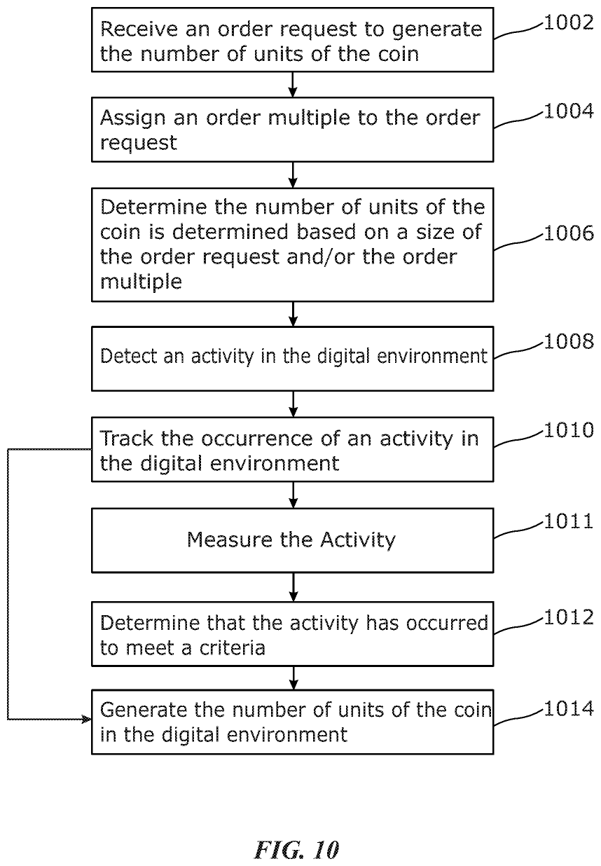

FIG. 11 depicts an example flow chart for using historical data stored on a block chain to determine the number of new coins or currency to be generated in response to an order request.

In process 1102, an order request to generate a number of new units of the currency is recorded on a block chain. The order request can be associated with a transfer of an initial number of existing units of the currency from a digital wallet to the block chain. For example, from a developer or publisher's digital wallet which has an existing amounts of currency units. Some of the existing amounts of currency units can be transferred as a seed amount to place the order request for new coin/currency units.

The order can exist on the block chain as its own smart contract, which can be subject to the global supply contract. In addition, the Publisher or developer can define the number of game play sessions (scores) required to fill the order. This parameter can include have a min and a max associated with it. “Lookback” can be a percentage of sessions defined.

In process 1104, an activity is detected in the digital environment. The activity, when performed can cause the creation of the new units of the coin/currency as for example, specified by the order request. In process 1106, an occurrence of the activity is tracked in the digital environment. In process 1108, the occurrence of the activity is recorded on the block chain.

In process 1110, statistics or history data pertaining to the activity is recorded on the block chain. For example, one embodiment includes a frequency operation to run to determine if a new pledge needs to be made. The frequency operation can “lookback” at the most recent x number of player scores

In process 1112, it is determined that the activity has occurred and the activity has occurred to meet a criteria. In process 1114, the number of units of the currency is generated in the digital environment, in response to determining that the activity has occurred and/or that the activity has occurred to meet a criteria.

The criteria can include, for instance, a number of times the activity has occurred in the digital environment. In one embodiment, the activity occurs in a game for a user to engage with to satisfy the criteria to generate the number of new units of the currency and the criteria can include a number of occurrences of the activity or a frequency of occurrences of the activity in the game.

The activity can occur in a game for a user to engage with to satisfy the criteria to generate the number of new units of the currency. In this example, statistics for the game can be recorded in the block chain to ascertain if the criteria to generate the number of new units of the currency is met or exceeded. Note that statistics recorded for the game in the block chain can include performance of the user in participating in the game or any other historical player or game session data or metadata. In one embodiment, the game can include multiple game sessions and statistics or performance data of each of the multiple game sessions are recorded on the block chain.

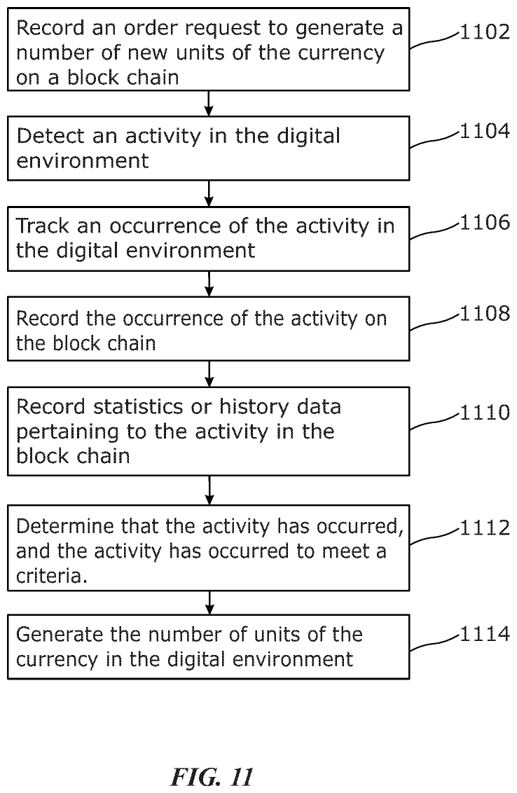

FIG. 12 depicts an example flow chart for determining a size of the order of new coin units to be created based on a total number of existing units of the coin and/or the seed size.

In one embodiment, the process can initiate with a game operator sending an existing amount of coin/currency (e.g., digital currencies, crypto currencies, crypto assets, etc.) from a wallet to the block chain. This seed opens the order system and allows the publisher to submit desired settings. In process 1202, a request is received for the order of the new units of the coin.

Depending on the total amount of units of the coin available worldwide at that time (current supply amount). For example, a smart contract running on the block chain can assign a multiple to the seed. As such, in process 1204, a total number of existing units of the coin in the digital environment is determined. In general, less units of a coin corresponds to a higher multiple, more units of a coin corresponds to a lower multiple.

As such, in process 1206, a larger value of the total number of existing units of the coin is associated with a lower value of the size of the order of the new units of the coin to be created. While in general, a lower value of the total number of existing units of the coin is associated with a higher value of the size of the order of the new units of the coin to be created, as in process 1208.

In process 1210, the size of the order of the new units of the coin is determined at least in part based on a multiple of the seed size. In process 1212, a value for the multiple is determined by asymptotic easing between a lower value and a higher value for the multiple. In one embodiment, the curve between the lowest and highest multiple will be a standard asymptotic easing, Other types of asymptotic easing can also be used.

Seed size will be capped in the overarching supply contract as well. The max seed size allowed can be, for example, governed by the event horizon date set in the master supply contract. If new coin creation is happening too quickly, max seed size can thus be lowered.

If new coin creation is happening to slowly in relation to the event horizon date, max seed size can then be increased, as illustrated in the example of FIG. 6. In process 1214, the seed size is associated with a maximum allowed value. In process 1216, the maximum allowed value is determined based on the total number of existing units of the coin.

Note that max seed size may not increase after a certain point, which corresponds to a hard cap or near hard cap of the seed size. In process 1218, an allowed value of the seed size is decreased with increased real time or relative time. In addition, or in alternate, an allowed value of the seed size is capped after a certain amount of time, as in process 1220. In process 1222, an allowed value of the seed size is determined based on a rate of change of the total number of existing units of the coin in the digital environment. In process 1224, the size of the order of new units of the coin to be created is determined based on a total number of existing units and/or the seed size.

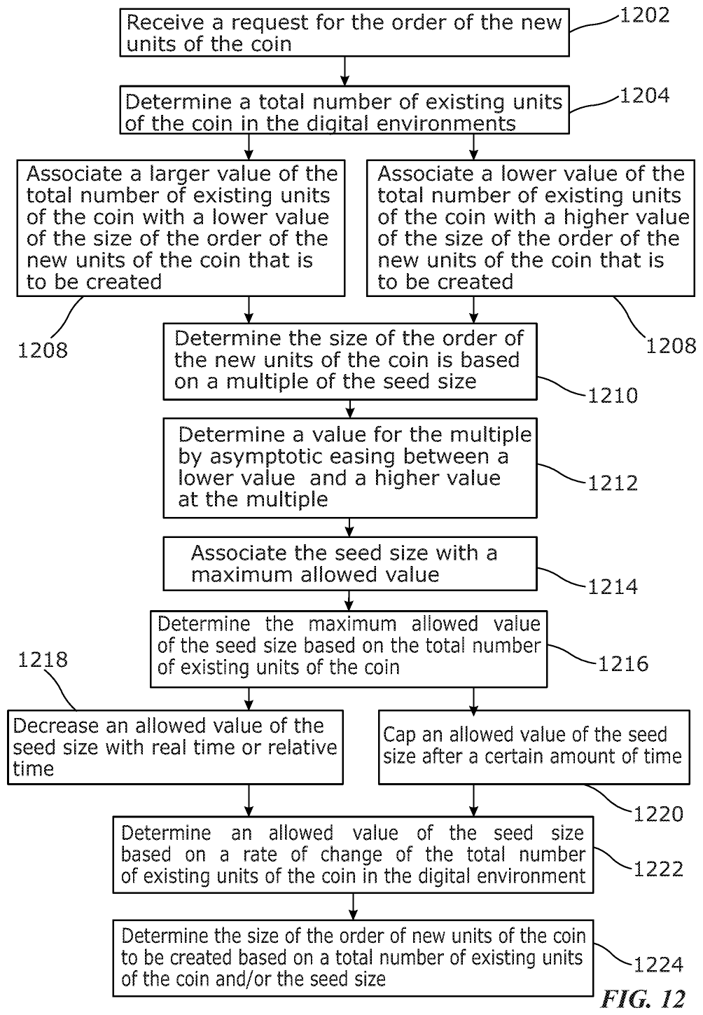

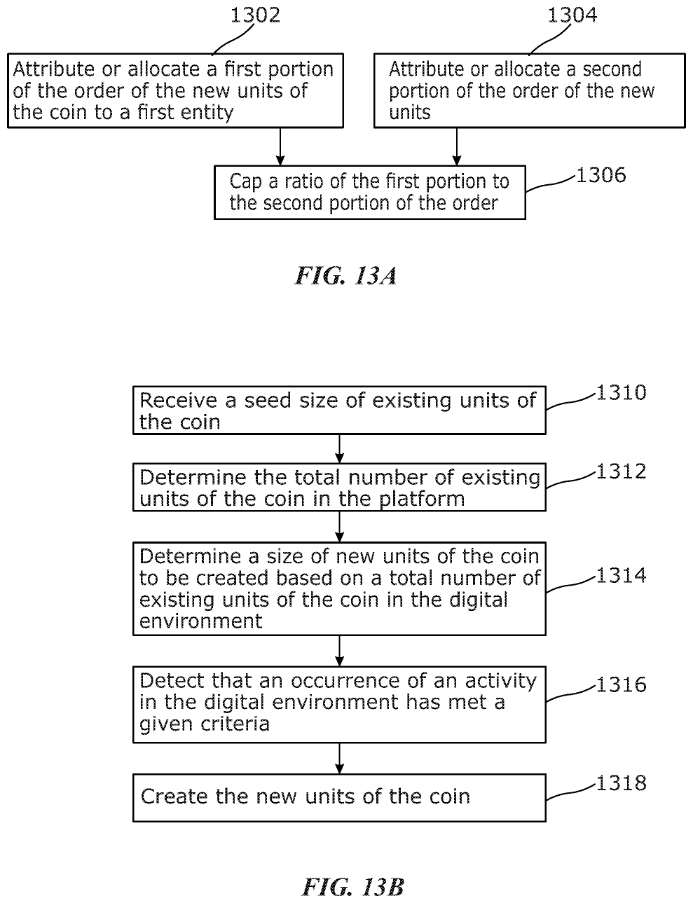

FIG. 13A depicts a flow chart illustrating an example process for allocating or attributing the newly generated coins or currency.

In process 1302, a first portion of the order of the new units of the coin is attributed or allocated to a first entity. In process 1304, a second portion of the order of the new units of the coin is attributed or allocated to a second entity.

In one embodiment, the first entity can supply or provide the seed size of the existing units of the coin associated with the request for the order. In addition, the second entity can engage in an activity where an occurrence of the activity is a criteria for the creation of the order of the new units of the coin.

When the entity places the order with the platform, part of the order indicates or specifies how much of the currency they intend to give to the users and how many they intend to keep for themselves. Note that for either entity zero is an acceptable parameter. It is also important to note that there may be multiple entities and many users.

In process 1306, a ratio of the first portion is capped to the second portion of the order. For example, a first portion of the number of the units of the coin newly created can be allocated or attributed to the publisher. Furthermore, a first percentage of the number of the units of the coin newly created are allocated or attributed to the publisher; wherein the first percentage is capped. A second portion of the number of the units of the coin newly created can be allocated or attributed to the player (e.g., user, gamer, worker, participant, etc.) and the second portion can be, for instance, allocated or attributed based on performance of the player in performing the activity

In the cases where there is no measurement, rewarding can be determined in advance by the first entity (e.g., the publisher, developer, owner, admin, etc.). For example the first entity can determine that the first 1000 opens of the game will generate a coin unit each. The initial tracking data is, for example, relied on to generate and attribute the coins to the various users.

When activities are measured, the attribution starts with the total amount of currency, subtracting any amount requested by the first entity (e.g., developer, publisher, admin, etc.). The system can reward the users (e.g. the second entity, player, gamer, etc.) the new coin/currency units based on and/or in relation to their relative performance. In general, the attribution of coins is a separate action or event from the generation of new coins units and the two can utilize different logic (e.g., entity determined or measurement determined).

FIG. 13B depicts a flow chart illustrating another example process for creating new units of a coin or currency. In one embodiment, the entity to deposits an amount of existing coin or currency to have the ability to place an order for new coin units to be created. In some embodiments, the entity may not be required to deposit an existing currency unit. In general, the order for more can be a multiple of the entity's deposit. In process 1310, a seed size of existing units of the coin is received. In one embodiment, receiving the seed size of existing units of the coin in the platform corresponds to receiving a request for the new units of the coin to be created. Note that submission of the seed amount is not required even though it can be an operational advantage or requirement of the platform in some cases.

In some instances, the seed size is assigned with a maximum allowed value. The maximum allowed value of the seed size can be determined based on the total number of existing units of the coin. Moreover, an allowed value of the seed size can decrease with real time, absolute time and/or relative time. In addition, an allowed value of the seed size can be capped after a certain amount of time and/or be determined based on a rate of change of the total number of existing units of the coin in the digital environment.

In process 1312, the total number of existing units of the coin in the platform is determined. In process 1314, a size of the new units of the coin to be created is determined based on a total number of existing coins in the digital environment. In general, a larger value of the total number of existing units of the coin is associated with a smaller value of the size of the new units of the coin to be created. A lower value of the total number of existing units of the coin can be associated with larger value of the size of the new units of the coin to be created.

In process 1316, it is detected that an occurrence of an activity in the digital environment has met a given criteria. In process 1318, the new units of the coin are created.

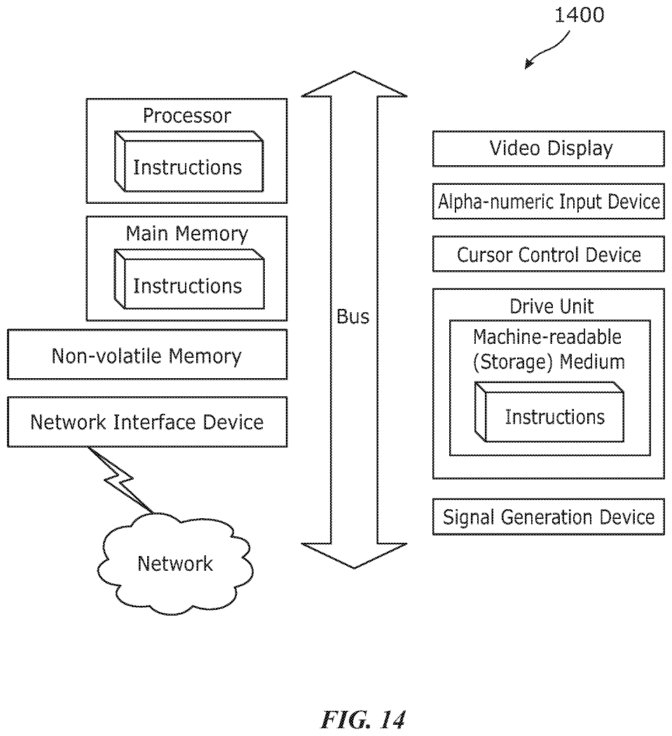

FIG. 14 shows a diagrammatic representation of a machine in the example form of a computer system within which a set of instructions, for causing the machine to perform any one or more of the methodologies discussed herein, may be executed.

In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a user device, a tablet PC, a laptop computer, a set-top box (STB), a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

The network interface device enables the machine 1100 to mediate data in a network with an entity that is external to the host server, through any known and/or convenient communications protocol supported by the host and the external entity. The network interface device can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

Other network security functions can be performed or included in the functions of the firewall, can be, for example, but are not limited to, intrusion-prevention, intrusion detection, next-generation firewall, personal firewall, etc. without deviating from the novel art of this disclosure.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further, any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, ¶6, other aspects may likewise be embodied as a means-plus-function claim, or in other forms, such as being embodied in a computer-readable medium. (Any claims intended to be treated under 35 U.S.C. § 112, ¶6 will begin with the words “means for”.) Accordingly, the applicant reserves the right to add additional claims after filing the application to pursue such additional claim forms for other aspects of the disclosure.

What is claimed is:

1. A method to determine a size of an order for new units of a coin to be created in a digital environment, the method, comprising:
receiving a request for the order of the new units of the coin;
wherein, the receiving of the request is associated with a seed size of existing units of the coin;
determining a total number of existing units of the coin in the digital environment;
determining the size of the order of new units of the coin to be created based on one or more of a total number of existing units of the coin in the digital environment and the seed size of the existing units of the coin associated with the request for the order.

2. The method of claim 1, further comprising, determining a rate of change of the total number of existing units of the coin in the digital environment.

3. The method of claim 1, wherein:
a larger value of the total number of existing units of the coin is associated with a lower value of the size of the order of the new units of the coin to be created;
a lower value of the total number of existing units of the coin is associated with higher value of the size of the order of the new units of the coin to be created.

4. The method of claim 1, wherein the size of the order of the new units of the coin is determined based on a multiple of the seed size; wherein a value for the multiple is determined by asymptotic easing between a lower value of the multiple and a higher value for the multiple.

5. The method of claim 1, wherein, creation of the order of the new units of the coin is associated with occurrence of an activity in the digital environment.

6. The method of claim 3, wherein, the order of the new units of the coin is created when the occurrence of the activity in the digital environment has met a given criteria.

7. The method of claim 1, wherein, the seed size is associated with a maximum allowed value.

8. The method of claim 6, wherein the maximum allowed value of the seed size is determined based on the total number of existing units of the coin.

9. The method of claim 1, wherein, an allowed value of the seed size decreases with real time or relative time.

10. The method of claim 1, wherein an allowed value of the seed size is capped after a certain amount of time.

11. The method of claim 1, wherein an allowed value of the seed size is determined based on a rate of change of the total number of existing units of the coin in the digital environment.

12. The method of claim 1, wherein, a first portion of the order of the new units of the coin is attributed or allocated to a first entity; wherein, a second portion of the order of the new units of the coin is attributed or allocated to a second entity.

13. The method of claim 12, wherein, a ratio of the first portion to the second portion of the order is substantially capped.

14. The method of claim 12, wherein the first entity supplies the seed size of the existing units of the coin associated with the request for the order; wherein the second entity engages in an activity; wherein an occurrence of the activity is a criteria for the creation of the order of the new units of the coin.

15. A machine-readable storage medium having stored thereon instructions which when executed by a processor, cause the processor to perform, a method to maintain a limited supply of a total number of existing units of a coin in a platform, the method, comprising:
receiving a seed size of existing units of the coin;
determining the total number of existing units of the coin in the platform;
determining a size of new units of the coin to be created based on one or more of a total number of existing units of the coin in the digital environment and the seed size of the existing units of the coin.

16. The method of claim 15, wherein the receiving the seed size of existing units of the coin in the platform corresponds to receiving a request for the new units of the coin to be created.

17. The method of claim 15, wherein:
a larger value of the total number of existing units of the coin is associated with a smaller value of the size of the new units of the coin to be created;
a lower value of the total number of existing units of the coin is associated with larger value of the size of the new units of the coin to be created.

18. The method of claim 15, wherein the size of the new units of the coin is determined based on a multiple of the seed size; wherein a value for the multiple is determined by asymptotic easing between a lower value of the multiple and a higher value for the multiple.

19. The method of claim 15, wherein, creation of the order of the new units of the coin is associated with occurrence of an activity or performance of an activity via the platform.

20. The method of claim 15, wherein, the new units of the coin are created when the occurrence of the activity in the digital environment has met a given criteria.

21. The method of claim 15, wherein, the seed size is assigned with a maximum allowed value.

22. The method of claim 21, wherein the maximum allowed value of the seed size is determined based on the total number of existing units of the coin.

23. The method of claim 21, wherein, an allowed value of the seed size decreases with real time or relative time.

24. The method of claim 21, wherein an allowed value of the seed size is capped after a certain amount of time.

25. The method of claim 21, wherein an allowed value of the seed size is determined based on a rate of change of the total number of existing units of the coin in the digital environment.

26. The method of claim 15, wherein, a first portion of the order of the new units of the coin is attributed to a first entity; wherein, a second portion of the order of the new units of the coin is attributed or allocated to a second entity; wherein the first entity supplies the seed size of the existing units of the coin associated with the request for the order; wherein the second entity engages in an activity; wherein an occurrence of the activity is a criteria for the creation of the order of the new units of the coin

27. The method of claim 26, wherein, a ratio of the first portion to the second portion of the order is substantially capped.

28. A system to control a supply of a total number of existing units of a coin in a platform, the system, comprising:
a processor;
a memory having stored thereon instructions, which when executed by the processor, cause the system to:
receive a seed size of existing units of the coin;
determine the total number of existing units of the coin in the platform;
control the supply of the total number of existing units of the coin by determining a size of new units of the coin to be created based on one or more of a total number of existing units of the coin in the digital environment and the seed size of the existing units of the coin.

29. The system of claim 28, wherein, creation of the order of the new units of the coin is associated with occurrence of an activity or performance of an activity via the platform.

30. The system of claim 28, wherein an allowed value of the seed size is determined based on a rate of change of the total number of existing units of the coin in the digital environment.
